(19) United States
(12) Patent Application Publication
(10) Pub. No.: US 2026/0161288 A1
(43) Pub. Date: Jun. 11, 2026

(54) TECHNIQUES FOR REDUCING COST OF POOLING AND SHARING OF COMPUTING DEVICE RESOURCES

(71) Applicant: Microsoft Technology Licensing, LLC, Redmond, WA (US)

(72) Inventors: Daniel Sebastian BERGER, Seattle, WA (US); Shuwei Teng, Woodinville, WA (US)

(21) Appl. No.: 18/977,391

(22) Filed: Dec. 11, 2024

(51) Int. Cl. G06F 3/06

(52) U.S. Cl. CPC G06F 3/0608; G06F 3/0631; G06F 3/067

(57) ABSTRACT

Described are examples for allocating memory from a pooled memory device having multiple memory devices or memory devices connected via one or more switches. Memory from at least a first memory device in a first set of the multiple memory devices to which a first host device is coupled can be allocated to the first host device. Memory from at least a second memory device in a second set of the multiple memory devices to which a second host device is coupled can be allocated to the second host device, where the first host device is uncoupled from at least the second memory device. In this regard, not every host device need be coupled to every memory device in the pooled memory device or memory devices connected via one or more switches.

### BACKGROUND

Technologies exist for interconnecting computing devices using a high-speed interfaces to facilitate resource pooling or sharing or communications between the devices. Once such technology is Compute express link (CXL), which allows pooling of memory resources among devices by interconnecting the devices via Peripheral Component Interconnect Express (PCIe) interface. CXL can be used in data centers to allow data center servers to access the same memory pool by connecting the servers to each CXL device in a pooled memory device. The pooled memory device can include multiple multi-headed CXL devices, where each multi-headed CXL device includes a memory and multiple heads (or ports) to which each data center server can be coupled, such that each of the multi-headed CXL devices are coupled to the same set of data center servers. In another configuration, CXL switches can be used to connect each of the data center servers to each of the CXL devices. In these configurations, the data center servers can share all memory of the pooled memory device over the high-speed PCIe interface. A data center server can request memory allocation from the pooled memory device, and the pooled memory device can provide the data center server with an allocation of memory that includes a uniform distribution of memory from each of the CXL devices in the pooled memory device. In addition, the pooled memory device can allocate memory from a CXL device to one data center server, and can later allocate the same memory to a different data center server coupled to the CXL device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a pooled memory device is provided that includes a bus, and multiple multi-headed memory devices coupled to the bus. A first multi-headed memory device of the multiple multi-headed memory devices is coupled to a first set of host devices, a second multi-headed memory device of the multiple multi-headed memory devices is coupled to a second set of the host devices, and the second multi-headed memory device of the multiple multi-headed memory devices, in operation, is uncoupled from at least one host device in the first set of the host devices such that the second multi-headed memory device allocates memory to the second set of the host devices without allocating any memory to the at least one host device in the first set of host devices.

In another example, a host device is provided that includes one or more processors, and one or more interfaces coupled to a set of memory devices. The host device is uncoupled from at least one memory device accessible in a memory device topology, such that, in operation, the at least one memory device of the memory devices in the memory device topology is unable to allocate memory to the host device.

In another example, a method for operating a device coupled with multiple memory devices is provided that includes allocating, to a first host device, memory from at least a first memory device in a first set of the multiple memory devices to which the first host device is coupled, and allocating, to a second host device, memory from at least a second memory device in a second set of the multiple memory devices to which the second host device is coupled. The first host device is uncoupled from at least the second memory device such that, in operation, at least the second memory device is unable to allocate memory to the first host device.

In other examples, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a memory device topology for connecting twelve hosts to three eight-port multi-headed memory devices, in accordance with aspects described herein.

FIG. 2 is a schematic diagram of an example of a memory device topology for connecting eight hosts to six four-port multi-headed memory devices, in accordance with aspects described herein.

FIG. 3 is a schematic diagram of an example of a memory device topology for connecting four hosts to six two-port multi-headed memory devices, in accordance with aspects described herein.

FIG. 4 is a schematic diagram of an example of a memory device topology 400 for connecting four hosts to two single-headed devices, in accordance with aspects described herein.

FIG. 5 illustrates an example of a pooled memory device that can be coupled with multiple host devices to provide pooled memory access thereto, in accordance with aspects described herein.

FIG. 6 illustrates a flowchart of an example of a method for operating a pooled memory device, in accordance with aspects described herein

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to reducing cost of memory pooling by allowing a set of memory devices with pooled memory to be coupled with different sets of host devices (and not requiring coupling of all memory devices with all host devices). In one example, the set of memory devices can be connected to different sets of hosts devices via switches, or can include multi-headed memory devices in a single pooled memory device where the multi-headed memory devices are each connected to different sets of host devices. In an example, the memory devices may include compute express link (CXL) devices and/or the switches may include CXL switches.

Cost of connecting multiple memory devices via switches, or cost of building multi-headed memory devices, can increase as the number of devices or ports increase due to manufacturing constraints. For multi-headed memory devices, the largest currently demonstrated number of ports is eight. In addition, increasing the size of the pool in the pooled memory device (e.g., by increasing the number of multi-headed CXL devices in the pooled memory device) can also lead to higher cost of such devices. Accordingly, aspects described herein relate to coupling memory devices to different sets of host devices, which can allow for supporting a larger number of host devices than conventional configurations that limit the number of host devices to the number of heads (or ports) on a combination of switches or on a given multi-headed memory device. In addition, in some examples, in connecting the host devices to the memory devices via switches, or to multi-headed memory devices, it can be ensured that each host device is connected to all other host devices in the set via at least one memory device to facilitate communication between the host devices by using memory space in the memory device.

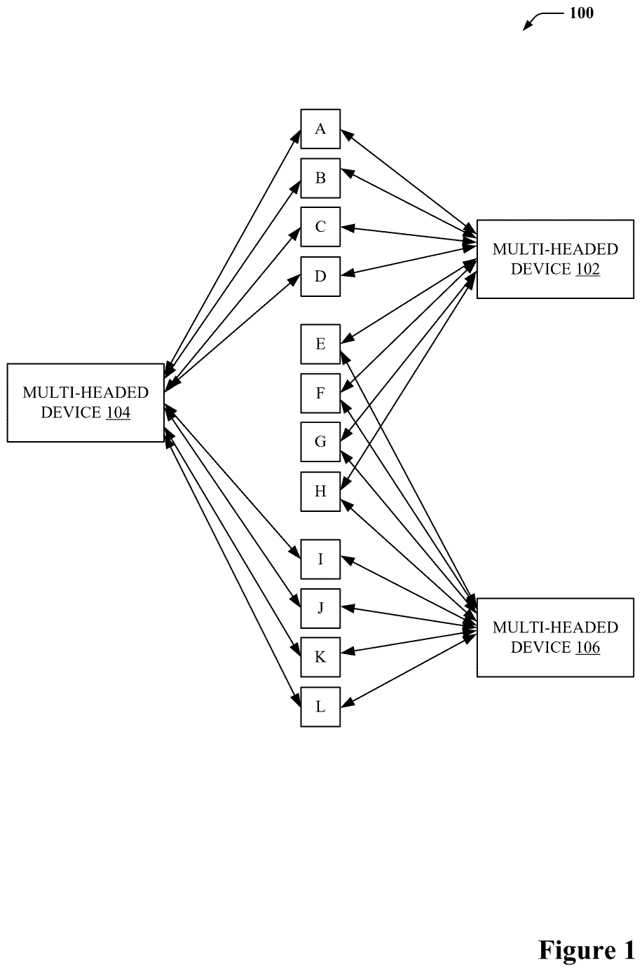

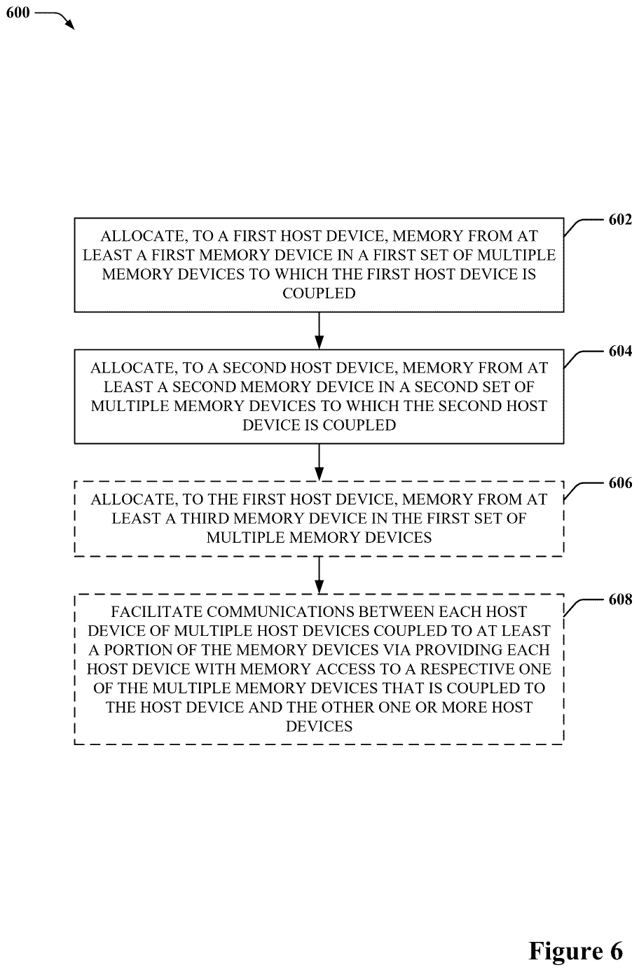

Turning now to FIGS. 1-6, examples are depicted with reference to one or more components and one or more methods that may perform the actions or operations described herein, where components and/or actions/operations in dashed line may be optional. Although the operations described below in FIG. 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a schematic diagram of an example of a memory device topology 100 for connecting twelve hosts to three eight-port multi-headed memory devices, in accordance with aspects described herein. The multi-headed memory devices 102, 104, 106 can each have eight ports for connecting to host devices, and the multi-headed memory devices 102, 104, 106 can be provided or managed by a single pooled memory device. In an example, each host device, A, B, C, D, E, F, G, H, I, J, K, L can be a served in a data center or substantially any computer that can be coupled to a multi-headed memory device. For example, the multi-headed memory device can be a CXL device that allows host devices to couple to it via a high-speed interface, such as Peripheral Component Interconnect Express (PCIe). In accordance with aspects described herein for example, each multi-headed memory device 102, 104, 106 can be communicatively coupled to a different set of the hosts devices (e.g., multi-headed memory device 102 can be communicatively coupled to host devices A, B, C, D, E, F, G, H; multi-headed memory device 104 can be communicatively coupled to host devices A, B, C, D, I, J, K, L; and multi-headed memory device 106 can be communicatively coupled to host devices E, F, G, H, I, J, K, L).

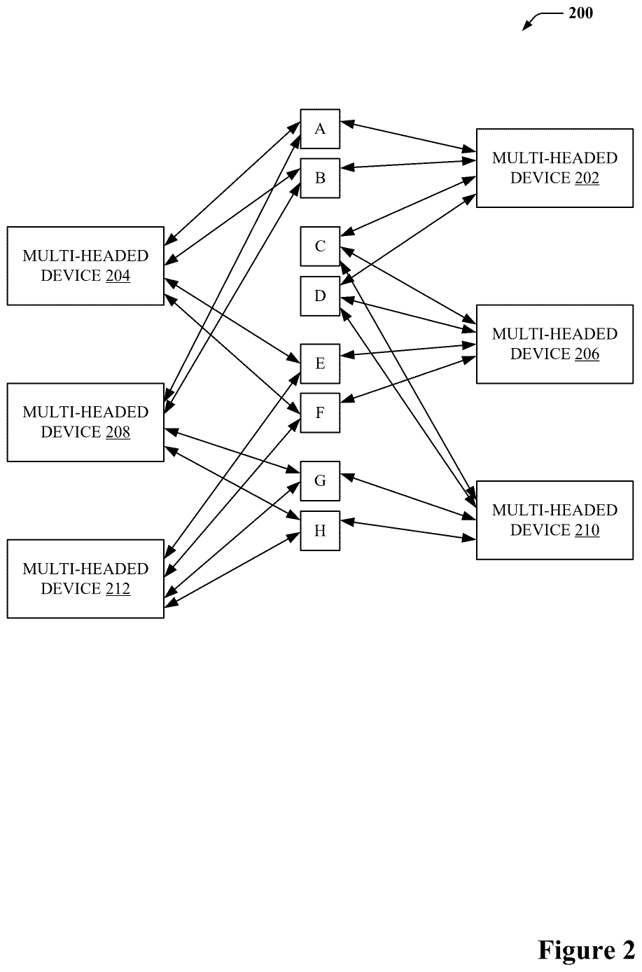

FIG. 2 is a schematic diagram of an example of a memory device topology 200 for connecting eight hosts to six four-port multi-headed memory devices, in accordance with aspects described herein. The multi-headed memory devices 202, 204, 206, 208, 210, 212 can each have four ports for connecting to host devices, and the multi-headed memory devices 202, 204, 206, 208, 210, 212 can be provided or managed by a single pooled memory device. In an example, each host device, A, B, C, D, E, F, G, H, can be a served in a data center or substantially any computer that can be coupled to a multi-headed memory device (e.g., via a high-speed interface, such as CXL using PCIe). As described, for example, each multi-headed memory device 202, 204, 206, 208, 210, 212 can be communicatively coupled to a different set of the hosts devices (e.g., multi-headed memory device 202 can be communicatively coupled to host devices A, B, C, D; multi-headed memory device 204 can be communicatively coupled to host devices A, B, E, F; multi-headed memory device 206 can be communicatively coupled to host devices C, D, E, F; multi-headed memory device 208 can be communicatively coupled to host devices A, B, G, H; multi-headed memory device 210 can be communicatively coupled to host devices C, D, G, H; and multi-headed memory device 212 can be communicatively coupled to host devices E, F, G, H).

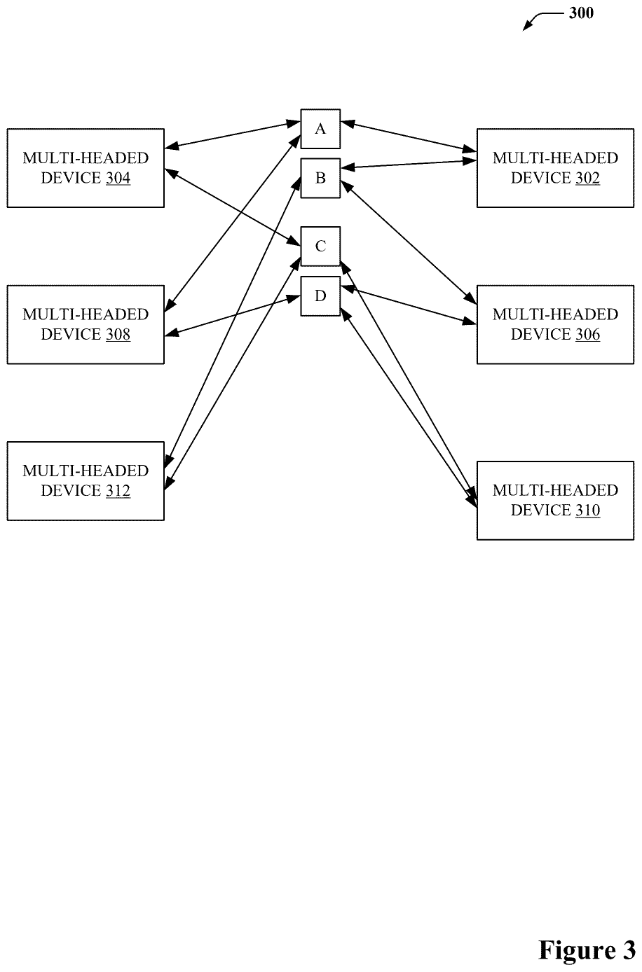

FIG. 3 is a schematic diagram of an example of a memory device topology 300 for connecting four hosts to six two-port multi-headed memory devices, in accordance with aspects described herein. The multi-headed memory devices 302, 304, 306, 308, 310, 312 can each have two ports for connecting to host devices, and the multi-headed memory devices 302, 304, 306, 308, 310, 312 can be provided or managed by a single pooled memory device. In an example, each host device, A, B, C, D, can be a served in a data center or substantially any computer that can be coupled to a multi-headed memory device (e.g., via a high-speed interface, such as CXL using PCIe). As described, for example, each multi-headed memory device 302, 304, 306, 308, 310, 312 can be communicatively coupled to a different set of the hosts devices (e.g., multi-headed memory device 302 can be communicatively coupled to host devices A, B; multi-headed memory device 304 can be communicatively coupled to host devices A, C; multi-headed memory device 306 can be communicatively coupled to host devices B, D; multi-headed memory device 308 can be communicatively coupled to host devices A, D; multi-headed memory device 310 can be communicatively coupled to host devices C, D; and multi-headed memory device 312 can be communicatively coupled to host devices B, C).

In the examples described in reference to FIGS. 1-3 above, and various examples described herein, the memory in the pooled memory device is not all accessible by a given host device (e.g., the memory of all of the multi-headed memory devices 102, 104, 106 is not accessible by any given host device A, B, C, D, E, F, G, H, I, J, K, or L), but each host device can be allocated memory from a set of multiple multi-headed memory devices. In addition, in the examples described in reference to FIGS. 1-3 above, and various examples described herein, each host device can be connected to every other host device that is coupled with the pooled memory device via one of the multi-headed memory devices. This can facilitate communication between a pair of the host devices by accessing memory in the multi-headed memory device that is coupled to both host devices in the pair. For example, a first host device can write to memory in the multi-headed memory device that is coupled to both host devices in the pair, and a second host device can read the memory in the multi-headed memory device that is coupled to both host devices in the pair. As the examples of deployments allow all host devices to be connected, communication between each of the host devices can be possible via the pooled memory device.

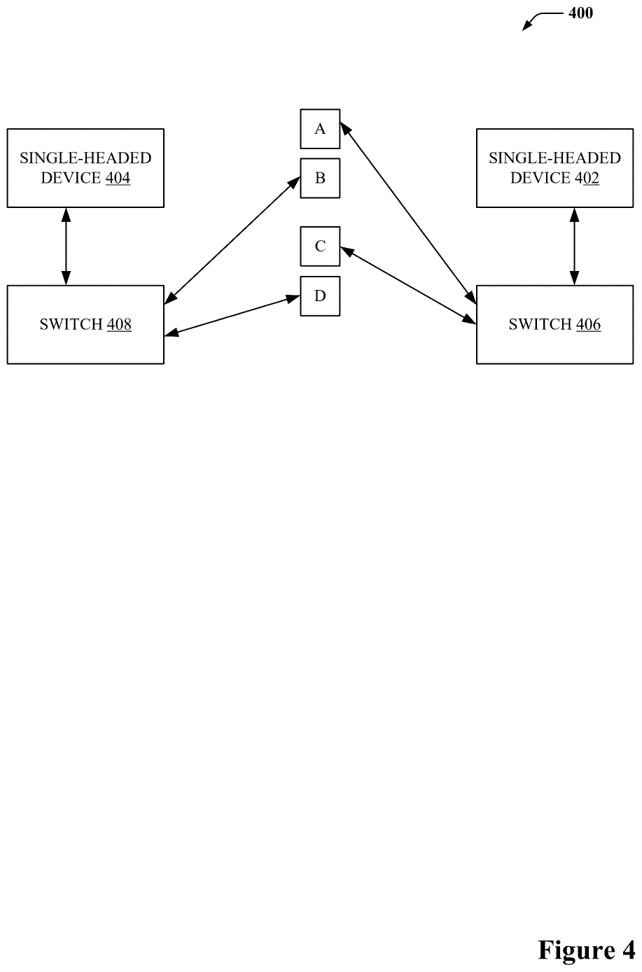

FIG. 4 is a schematic diagram of an example of a memory device topology 400 for connecting four hosts to two single-headed devices, in accordance with aspects described herein. The single-headed devices 402, 404 can each have one port for connecting to switch 406, 408, and host devices can also connect to a switch 406, 408. In an example, each host device, A, B, C, D, can be a served in a data center or substantially any computer that can be coupled to a switch for accessing memory devices (e.g., via a high-speed interface, such as CXL using PCIe). As described, for example, each single-headed device 402, 404 can be communicatively coupled to a different set of the hosts devices via the switches 406, 408 (e.g., single-headed device 402 can be communicatively coupled to host devices A, C via switch 406; single-headed device 404 can be communicatively coupled to host devices B, D via a switch 408). Similarly, in this example, each switch and single-headed device are coupled to a subset of the host devices that is less than all host devices, but each host device is coupled to a memory device. In addition, each host device A, B, C, D can be coupled with all other host devices via a single-headed device 402 or 404 to allow communications between the host devices using a single-headed device.

In other topologies, a multi-headed memory device may be coupled to multiple switches, and host devices may be coupled to one or more of the multiple switches as well to access a respective multi-headed memory device. However, all host devices need not be coupled to all multi-headed memory devices, in accordance with the examples described above. In addition, the host devices may be connected in the topology such that each host device can communicate with all other host devices via at least one multi-headed memory device to facilitate communication among the host devices by sharing memory of the at least one multi-headed memory device.

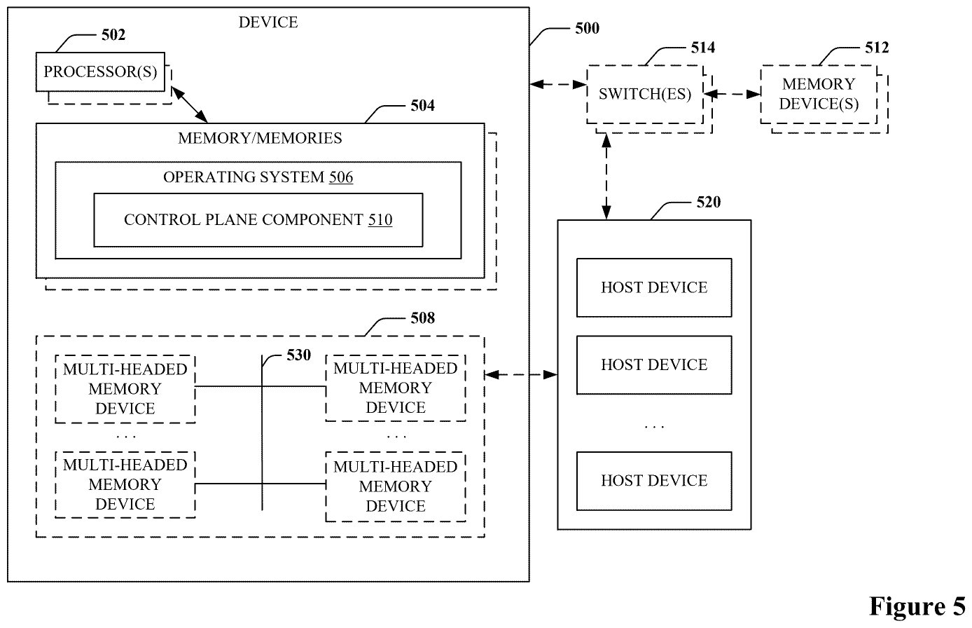

FIG. 5 illustrates an example of a device 500 that can be coupled with multiple host devices 520 to provide pooled memory access thereto, in accordance with aspects described herein. In an example, device 500 can include one or more processors 502 and/or memory/memories 504 configured to execute or store instructions or other parameters related to providing an operating system 506, which can execute one or more applications or processes. For example, processor(s) 502 and memory/memories 504 may be separate components communicatively coupled by a bus (e.g., on a motherboard or other portion of a computing device, on an integrated circuit, such as a system on a chip (SoC), etc.), components integrated within one another (e.g., processor(s) 502 can include the memory/memories 504 as an on-board component), and/or the like. Memory/memories 504 may store instructions, parameters, data structures, etc. for use/execution by processor(s) 502 to perform functions described herein.

In one example, the operating system 506 can execute one or more applications or processes, such as, but not limited to, a control plane component 510 for allocating memory resources of memory devices 508 or memory devices 512 to one or more host devices 520. In one example, in accordance with some topologies described herein, device 500 can be a pooled memory device that includes the multiple multi-headed memory devices 508, which can be communicatively coupled by a bus 530, which may be the same or different bus to which the processor(s) 502 and/or memory/memories 504 are communicatively coupled. In this example, processor(s) 502 and/or memory/memories 504 (and/or operating system 506 and/or control plane component 510) can access the multiple multi-headed memory devices 508 via the bus 530 to facilitate allocating memory of the multi-headed memory devices to one or more host devices 520. In this example, the host devices 520 can be communicatively coupled to the multi-headed memory devices 508 (e.g., via a high-speed interface) as described above, e.g., such that two host devices are respectively coupled to a different set of multi-headed memory devices, or said differently, at least one multi-headed memory device is not communicatively coupled to all host devices 520 (e.g., via a high-speed interface). In this example, control plane component 510 can allocate memory resources from the multi-headed memory devices 508 to the host devices 520 based on the topology of the multi-headed memory devices 508 to the host devices 520.

In another example, in accordance with other topologies described herein, device 500 can be coupled with memory devices 512 via one or more switches 514, and control plane component 510 can allocate memory from the memory devices 512 to one or more host devices 520 based on the memory devices 512 to which the host devices 520 are connected via the one or more switches 514. In either example, given that a host device 520 may not be coupled to all of the memory devices 508 in a pooled memory device configuration, or memory devices 512 in a switched configuration with switches 514, uniform memory allocation among the memory devices to which the host devices is connected may not be optimal.

In this regard, for example, control plane component 510 can allocate memory resources of the set of memory devices 508, or memory device 512, that are coupled to a given host device requesting memory allocation based on a proportion of an amount memory available at each memory device in the set of memory devices that are coupled to the given host device. For example, for a host device coupled with two memory devices, where a first device has 150 GB available and a second device as 50 GB available, where the host device requests allocation of 100 GB, control plane component 510 can allocate, and the first host device can receive the allocation of, memory resources from the memory devices in proportion of the available memory (e.g., 150 GB/200 GB for the first device and 50 GB/200 GB for the second device), which can result in allocating 75 GB from the first device and 25 GB from the second device. In another example, control plane component 510 can allocate memory resources of the set of memory devices that are coupled to a given host device requesting memory allocation based on which of the memory devices that are coupled to the given host device have the most memory available or largest memory capacity.

FIG. 6 is a flowchart of an example of a method 600 for operating a device that allocates memory, in accordance with aspects described herein. For example, method 600 can be performed by a device 500 and/or one or more components thereof to facilitate allocating memory from memory devices to host devices, as described herein.

In method 600, at action 602, memory can be allocated, to a first host device, from at least a first memory device in a first set of multiple memory devices to which the first host device is coupled. In an example, control plane component 510, e.g., in conjunction with processor(s) 502, memory/memories 504, operating system 506, etc., can allocate, to the first host device (e.g., one of host devices 520), memory from at least a first memory device (e.g., one of multi-headed memory devices 508 or one of memory devices 512) in a first set of multiple memory devices (e.g., a set of multi-headed memory devices 508 or a set of memory devices 512 coupled to one or more switches 514) to which the first host device is coupled. For example, this can be based on a request from the first host device to allocate memory from the device 500. In addition, as described above, the first host device can be coupled to the first set of multiple memory device not including all memory devices within the device, or otherwise coupled to the device 500 via one or more switches 514.

In method 600, at action 604, memory can be allocated, to a second host device, from at least a second memory device in a second set of multiple memory devices to which the second host device is coupled. In an example, control plane component 510, e.g., in conjunction with processor(s) 502, memory/memories 504, operating system 506, etc., can allocate, to the second host device (e.g., one of host devices 520 different from the first host device), memory from at least a second memory device (e.g., one of multi-headed memory devices 508 or one of memory devices 512) in a second set of multiple memory devices (e.g., a set of multi-headed memory devices 508 different from the first set of multi-headed memory devices, or a second set of memory devices 512 different from the first set of memory devices) to which the second host device is coupled. For example, this can be based on a request from the second host device to allocate memory from the device 500.

In addition, as described above, the second host device can be coupled to the second set of multiple memory devices not including all memory devices within the device, or otherwise coupled to the device 500 via one or more switches 514, and different from the first set of memory devices to which the first host device is coupled. In this regard, for example, during operation of the device that allocates memory, and/or during operation of the associated individual memory devices, the second memory device of the multiple memory devices, which is uncoupled from the first host device can allocate memory to the second host device, and/or other host devices to which the second memory device may be coupled, without allocating memory to the first host device. In this example, the second memory device may be unable to allocate memory to the first host device due to the devices being uncoupled.

In method 600, optionally at action 606, memory from at least a third device in the first set of multiple memory devices can be allocated to the first host device. In an example, control plane component 510, e.g., in conjunction with processor(s) 502, memory/memories 504, operating system 506, etc., can allocate, to the first host device, memory from at least a third memory device in the first set of multiple memory devices. As described, for example, the first host device can be coupled to multiple memory devices (e.g., the first and third memory devices via PCIe connection to multi-headed devices 508 or via one or more switches 514 to memory devices 512), and control plane component 510 can allocate memory from each device in proportion to memory available at the respective devices or based on which device has more memory available.

In method 600, optionally at action 608, communications between each host device of multiple host devices coupled to at least a portion of the memory devices can be facilitated via providing each host device with memory access to a respective one of the multiple memory devices that is coupled to the host device and the other one or more host devices. In an example, control plane component 510, e.g., in conjunction with processor(s) 502, memory/memories 504, operating system 506, etc., can facilitate communications between each host device of multiple host devices coupled to at least a portion of the memory devices via providing each host device with memory access to a respective one of the multiple memory devices that is coupled to the host device and the other one or more host devices. For example, as described above, based on the memory device topology, each host device can communicate with every other host device coupled to the device 500 by accessing a common memory device between the host devices to write or read data in allocated memory resources. For example, the common memory device can include a multi-headed device to which the host device and the other one or more host devices are coupled via a PCIe or similar connection, or can include a memory device to which the host device and the other one or more host devices via one or more switches.

Some further example aspects are provided below.
Aspect 1 is a pooled memory device including a bus, and multiple multi-headed memory devices coupled to the bus. A first multi-headed memory device of the multiple multi-headed memory devices is coupled to a first set of host devices, a second multi-headed memory device of the multiple multi-headed memory devices is coupled to a second set of the host devices, and the second multi-headed memory device of the multiple multi-headed memory devices, in operation, is uncoupled from at least one host device in the first set of the host devices such that the second multi-headed memory device allocates memory to the second set of the host devices without allocating any memory to the at least one host device in the first set of host devices.
In Aspect 2, the pooled memory device of Aspect 1 includes where the first multi-headed memory device and the second multi-headed memory device are CXL memory devices.
In Aspect 3, the pooled memory device of any of Aspects 1 or 2 includes one or more processors configured for allocating memory of the first multi-headed memory device to the first set of the host devices and for allocating memory of the second multi-headed memory device to the second set of the host devices.
In Aspect 4, the pooled memory device of Aspect 3 includes where a third multi-headed memory device of the multiple multi-headed memory devices is coupled to at least one host device of the first set of the host devices, and where the one or more processors are configured for allocating, to the at least one host device, memory of the first multi-headed memory device and allocating memory of the third multi-headed memory device in proportion of a first amount of memory available at the first multi-headed memory device and a second amount of memory available at the third multi-headed memory device.
In Aspect 5, the pooled memory device of any of Aspects 3 or 4 includes where a third multi-headed memory device of the multiple multi-headed memory devices is coupled to at least one host device of the first set of the host devices, and where the one or more processors are configured for allocating, to the at least one host device, memory of the first multi-headed memory device or allocating memory of the third multi-headed memory device based on whether the first multi-headed memory device or the third multi-headed memory device has more available memory.
In Aspect 6, the pooled memory device of any of Aspects 1 to 5 includes where each of the host devices is coupled to a same one of the multiple multi-headed memory devices as each of the other host devices and at least one host device of the host devices is uncoupled from at least one of the multiple multi-headed memory devices.
In Aspect 7, the pooled memory device of any of Aspects 1 to 6 includes where each of the host devices are configured to communicate with each of the other host devices via accessing memory of a respective one of the multiple multi-headed memory devices that is coupled to the host devices and the other host devices.
Aspect 8 is a host device including one or more processors, and one or more interfaces coupled to a set of memory devices, where the host device is uncoupled from at least one memory device accessible in a memory device topology, such that, in operation, the at least one memory device of the memory devices in the memory device topology is unable to allocate memory to the host device.
In Aspect 9, the host device of Aspect 8 includes where the set of memory devices are multi-headed CXL memory devices.
In Aspect 10, the host device of Aspect 9 includes where the set of memory devices include multi-headed memory devices in a pooled memory device, and where the one or more processors are configured to request allocation of memory from the pooled memory device, and receive, from the pooled memory device, the allocation of memory from one of the set of multi-headed CXL devices.
In Aspect 11, the host device of Aspect 10 includes where the one or more processors are configured to communicate with a second host device by accessing, via the pooled memory device, memory from one of the set of memory devices that is coupled to the second host device.
In Aspect 12, the host device of any of Aspects 8 to 11 includes where the one or more interfaces are coupled to the set of memory devices via a switch.
Aspect 13 is a method for operating a device coupled with multiple memory devices that includes allocating, to a first host device, memory from at least a first memory device in a first set of the multiple memory devices to which the first host device is coupled, and allocating, to a second host device, memory from at least a second memory device in a second set of the multiple memory devices to which the second host device is coupled, where the first host device is uncoupled from at least the second memory device such that, in operation, at least the second memory device is unable to allocate memory to the first host device.
In Aspect 14, the method of Aspect 13 includes where the first set of the multiple memory devices and the second set of the multiple memory devices include multi-headed CXL memory devices.
In Aspect 15, the method of any of Aspects 13 or 14 includes allocating, to the first host device, memory from at least a third memory device in the first set of the multiple memory devices, where allocating memory to the first host device from at least the first memory device and at least the third memory device is in proportion of a first amount of memory available at the first memory device and a second amount of memory available at the third memory device.
In Aspect 16, the method of any of Aspects 13 to 15 includes allocating, to the first host device, memory from at least a third memory device in the first set of the multiple memory devices, where allocating memory to the first host device from at least the first memory device and at least the third memory device is based on whether the first memory device or the third memory device has more available memory.
In Aspect 17, the method of any of Aspects 13 to 16 includes facilitating communications between each host device of multiple host devices coupled to at least a portion of the memory devices via providing each host device with memory access to a respective one of the multiple memory devices that is coupled to the host device and the other host devices.
In Aspect 18, the method of any of Aspects 13 to 17 includes where the first set of the multiple memory devices and the second set of the multiple memory devices are coupled with the first host device and the second host device via a switch.
In Aspect 19, the method of Aspect 18 includes where the first set of the multiple memory devices and the second set of the multiple memory devices include multi-headed CXL memory devices, and where the switch is a CXL switch.
Aspect 20 is an apparatus including one or more processors, one or more memories coupled with the one or more processors, and instructions stored in the one or more memories and operable, when executed by the one or more processors, to cause the apparatus to perform any of the methods of Aspects 13 to 19.
Aspect 21 is an apparatus for including means for performing any of the methods of Aspects 13 to 19.
Aspect 22 is one or more computer-readable media including code executable by one or more processors, the code including code for performing any of the methods of Aspects 13 to 19.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), central processing units (CPUs), graphics processing units (GPUs), application-specific integrated circuits (ASICs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random access memory (RAM), read only memory (ROM), electrically erasable programmable ROM (EEPROM), CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A pooled memory device, comprising:
a bus; and
multiple multi-headed memory devices coupled to the bus,
wherein a first multi-headed memory device of the multiple multi-headed memory devices is coupled to a first set of host devices,
wherein a second multi-headed memory device of the multiple multi-headed memory devices is coupled to a second set of the host devices, and
wherein the second multi-headed memory device of the multiple multi-headed memory devices, in operation, is uncoupled from at least one host device in the first set of the host devices such that the second multi-headed memory device allocates memory to the second set of the host devices without allocating any memory to the at least one host device in the first set of host devices.

2. The pooled memory device of claim 1, wherein the first multi-headed memory device and the second multi-headed memory device are compute express link (CXL) memory devices.

3. The pooled memory device of claim 1, further comprising one or more processors configured for allocating memory of the first multi-headed memory device to the first set of the host devices and for allocating memory of the second multi-headed memory device to the second set of the host devices.

4. The pooled memory device of claim 3, wherein a third multi-headed memory device of the multiple multi-headed memory devices is coupled to the at least one host device of the first set of the host devices, and wherein the one or more processors are configured for allocating, to the at least one host device, memory of the first multi-headed memory device and allocating memory of the third multi-headed memory device in proportion of a first amount of memory available at the first multi-headed memory device and a second amount of memory available at the third multi-headed memory device.

5. The pooled memory device of claim 3, wherein a third multi-headed memory device of the multiple multi-headed memory devices is coupled to at least one host device of the first set of the host devices, and wherein the one or more processors are configured for allocating, to the at least one host device, memory of the first multi-headed memory device or allocating memory of the third multi-headed memory device based on whether the first multi-headed memory device or the third multi-headed memory device has more available memory.

6. The pooled memory device of claim 1, wherein each of the host devices is coupled to a same one of the multiple multi-headed memory devices as each of the other host devices and the at least one host device is uncoupled from at least one of the multiple multi-headed memory devices.

7. The pooled memory device of claim 1, wherein each of the host devices are configured to communicate with each of the other host devices via accessing memory of a respective one of the multiple multi-headed memory devices that is coupled to the host devices and the other host devices.

8. A host device, comprising:
one or more processors; and
one or more interfaces coupled to a set of memory devices, wherein the host device is uncoupled from at least one memory device accessible in a memory device topology, such that, in operation, the at least one memory device of the memory devices in the memory device topology is unable to allocate memory to the host device.

9. The host device of claim 8, wherein the set of memory devices are multi-headed compute express link (CXL) memory devices.

10. The host device of claim 9, wherein the set of memory devices include multi-headed memory devices in a pooled memory device, and wherein the one or more processors are configured to:
request allocation of memory from the pooled memory device; and
receive, from the pooled memory device, the allocation of memory from one of the set of multi-headed CXL devices.

11. The host device of claim 10, wherein the one or more processors are configured to communicate with a second host device by accessing, via the pooled memory device, memory from one of the set of memory devices that is coupled to the second host device.

12. The host device of claim 8, wherein the one or more interfaces are coupled to the set of memory devices via a switch.

13. A method for operating a device coupled with multiple memory devices, comprising:
allocating, to a first host device, memory from at least a first memory device in a first set of the multiple memory devices to which the first host device is coupled; and
allocating, to a second host device, memory from at least a second memory device in a second set of the multiple memory devices to which the second host device is coupled,
wherein the first host device is uncoupled from at least the second memory device such that, in operation, at least the second memory device is unable to allocate memory to the first host device.

14. The method of claim 13, wherein the first set of the multiple memory devices and the second set of the multiple memory devices include multi-headed compute express link (CXL) memory devices.

15. The method of claim 13, further comprising allocating, to the first host device, memory from at least a third memory device in the first set of the multiple memory devices, wherein allocating memory to the first host device from at least the first memory device and at least the third memory device is in proportion of a first amount of memory available at the first memory device and a second amount of memory available at the third memory device.

16. The method of claim 13, further comprising allocating, to the first host device, memory from at least a third memory device in the first set of the multiple memory devices, wherein allocating memory to the first host device from at least the first memory device and at least the third memory device is based on whether the first memory device or the third memory device has more available memory.

17. The method of claim 13, further comprising facilitating communications between each host device of multiple host devices coupled to at least a portion of the memory devices via providing each host device with memory access to a respective one of the multiple memory devices that is coupled to the host device and the other host devices.

18. The method of claim 13, wherein the first set of the multiple memory devices and the second set of the multiple memory devices are coupled with the first host device and the second host device via a switch.

19. The method of claim 18, wherein the first set of the multiple memory devices and the second set of the multiple memory devices include multi-headed compute express link (CXL) memory devices, and wherein the switch is a CXL switch.
